(19) United States
(12) Patent Application Publication
(10) Pub. No.: US 2020/0283955 A1
(43) Pub. Date: Sep. 10, 2020

(54) REFINING SET

(71) Applicant: Voith Patent GmbH, Heidenheim (DE)

(72) Inventor: Gert Gottschalk, Ravensburg (DE)

(73) Assignee: Voith Patent GmbH, Heidenheim (DE)

(21) Appl. No.: 16/883,171

(22) Filed: May 26, 2020

Related U.S. Application Data
(62) Division of application No. 15/972,615, filed on May 7, 2018.
Application No. 15/972,615 is a continuation of application No. PCT/EP2016/074303, filed on Oct. 11, 2016.

(30) Foreign Application Priority Data
Nov. 23, 2015 (DE) 10 2015 223 027.9

(51) Int. Cl. D21D 1/30

(52) U.S. Cl. CPC D21D 1/303; B02C 7/04; D21D 1/306

(57) ABSTRACT

The invention relates to a refining assembly for refining water-suspended pulp fibers between two coaxial refining surfaces which form a refining gap, rotate in relation to each other and are formed by refining bars and grooves extending therebetween. At least one directional component of the refining bars extends radially in relation to the axis of rotation. In order make the refining process more efficient, the refining bars have annular elevations and depressions that run concentrically to the axis of rotation of the refining surfaces and an annular elevation of one refining surface protruding into an annular depression in an opposite refining surface.

### CROSS REFERENCE TO RELATED APPLICATIONS

This is a division of U.S. patent application Ser. No. 15/972,615, entitled “REFINING SET”, filed May 7, 2018, which is a continuation of PCT application No. PCT/EP2016/074303, entitled “REFINING SET”, filed Oct. 11, 2016, which are both incorporated herein by reference.

### BACKGROUND OF THE INVENTION

### 1. Field of the Invention

The invention relates to a refining assembly, and more particularly, to a refining assembly for refining aqueous suspended fibers.

### 2. Description of the Related Art

It has been known for a long time to refine cellulose fibers, in other words virgin pulp and/or recycled fibers in order to obtain the desired characteristics in the thus produced fibrous web, in particular in regard to strength, forming and surface properties.

Due to the relatively rapid wear and tear in the case of the refiners used for this purpose, the refining surfaces are formed by replaceable refining sets that are screwed together with the corresponding supporting surface.

To achieve the desired fiber properties, in particular the degree of refining, the refining sets must be adapted as effectively as possible to the pulp that is to be treated—also in order to prevent excessive wear and tear to the sets.

In order to increase the efficiency of fiber treatment, optimal utilization of the available refining surface is strived for.

What is needed in the art is an improvement in the efficiency of fiber treatment.

### SUMMARY OF THE INVENTION

According to an embodiment of the invention, a refining assembly for refining aqueous suspended cellulose fibers includes two refining surfaces arranged coaxially to one another and forming a refining gap. The two refining surfaces are configured to rotate relative to one another and are formed by refining bars and grooves extending between them. At least one directional component of the refining bars extends radially relative to an axis of rotation.

According to an embodiment of the invention, the refining bars have annular elevations and depressions that run concentrically to the axis of rotation of the refining surfaces, whereby an annular elevation of one refining surface protrudes into an annular depression of the opposite refining surface.

This forces a shift of part of the cellulose fibers from one refining surface to the opposite refining surface, resulting in a considerable increase in the intensity of the treatment.

In order to maintain the intensity in radial direction, and according to another embodiment of the invention, the distance between the refining bars of the opposite refining surfaces should remain the same in radial direction.

In order to increase efficiency, and accordioning to another embodiment of the invention, additional turbulences and shifts between the refining surfaces can also be achieved in that the grooves have annular elevations and depressions that run concentrically to the axis of rotation of the refining surfaces, whereby an annular elevation of one refining surface protrudes into an annular depression of the opposite refining surface.

To avoid blockages, the distance between the grooves in the opposite refining surfaces should remain the same in radial direction also in this case.

In the interest of an efficient but at the same time gentle fiber treatment it is however advantageous if the radial position of the elevations or respectively depressions in the refining bars corresponds with the radial position of the elevations or respectively the depressions in the grooves of a refining surface.

To minimize wear and tear, the height of the annular elevations or respectively depressions should gradually increase and/or gradually decrease in radial direction.

In an embodiment, the height of the elevations or respectively depressions of the refining bar and the grooves relates to the respective supporting surface for the refining sets that form the refining surface. Depending on the type of refiner, these supporting surfaces for mounting of the refining sets are either flat or conical.

For an intensive turbulence it can however be advantageous if the height of the annular elevation or respectively depression increases in radial direction in one or several increments and or decreases in one or several increments.

Combinations are herein also possible, for example gradually increasing elevations or respectively depressions and incrementally decreasing elevations or respectively depressions, or vice versa.

In one embodiment, and for optimal use of both refining surfaces, elevations and depressions should alternate in both refining surfaces in radial direction.

Depending on the type of fibrous material and the requirements of the treatment thereof it may be sufficient, if elevations and depressions extend only over a partial radial section of the refining surface.

Comprehensive use of the advantages of the invention results however, if the elevations and depressions extend over the entire refining surface.

Moreover, the flow through the refining gap can also be impeded in that at least some grooves are closed off at least partially by barriers. This also intensifies the fiber treatment.

In the final analysis, considerable energy savings can thus be achieved.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic cross section through a refining arrangement, according to an embodiment of the invention;

FIG. 2 is a top view onto a refining disk, according to an embodiment of the invention; and

FIGS. 3-6 are partial radial cross section views through various refining disks, according to an embodiment of the invention.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

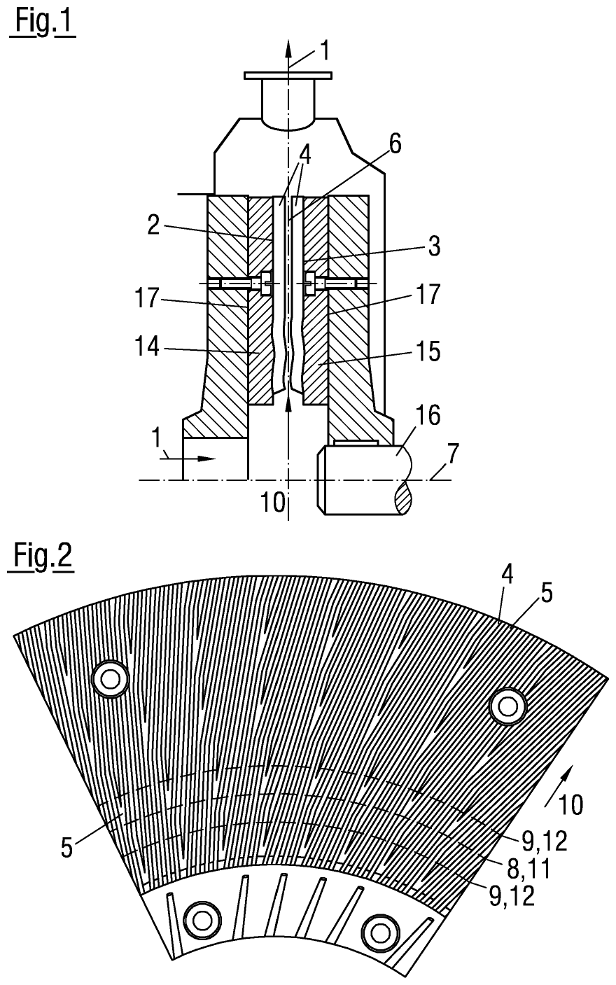

According to FIG. 1, a refining gap 6 is formed in the housing of the refining assembly, including a stationary refining surface 2 that is coupled with the housing and a refining surface 3 that rotates about a rotational axis 7, according to an embodiment of the invention.

The two annular refining surfaces 2, 3 are positioned parallel to one another, wherein the distance between them is generally adjustable.

Rotating refining surface 3 is herein moved in rotational direction by a shaft 16 that is rotatably mounted in the housing. Shaft 16 is driven by a drive that is also located in the housing.

In the herein illustrated example, the fibrous suspension that is to be refined and which contains cellulose fibers 1 runs via an infeed through the center into refining gap 6 between the two refining surfaces 2, 3.

The fibrous suspension passes interacting refining surfaces 2, 3 in radially outward direction and exits the adjacent annulus through an outlet.

Means that are generally known with which power is generated in order to press the two refining surfaces 2, 3 against one another are not illustrated.

Both refining surfaces 2, 3 are respectively formed by several refining disks 14, 15 as illustrated in FIG. 2 that extend respectively over a circumferential segment of the corresponding refining surface 2, 3 and which are also referred to as refining sets.

Refining disks 14, 15 that are arranged closely adjacent next to one another provide a continuous refining surface 2, 3 in circumferential direction. Refining disks 14, 15 respectively are mounted on a flat supporting surface 17.

As illustrated in FIG. 2, refining disks 14, 15 and thus also refining surfaces 2, 3 are formed by a plurality of radially progressing refining bars 4 and grooves 5 between them.

The cross section of refining bars 4 which are also referred to as blades is generally rectangular. However, the scope of the present invention covers other shapes.

Grooves 5 between refining bars 4 also have a rectangular cross section and serve as flow channels for the fibrous suspension. The groove depth is generally between 2 and 20 mm.

So that the groove width does not become too large in radially outward direction at a constant and uniform width of refining bars 4, refining bars 4 can be split or newly added in radial direction 10.

According to an embodiment of the invention, refining bars 4 have annular elevations 8 and depressions 9 that run concentrically to axis of rotation 7 of refining surfaces 2,3, whereby an annular elevation 8 of one refining surface 2, 3 protrudes into an annular depression 9 of opposite refining surface 2,3.

Due to elevations 8 and depressions 9, turbulences are caused in the fibrous suspension that is to be treated. Moreover, when flowing through refining gap 6, the fibrous suspension is forced at least partially to shift between refining surfaces 2, 3.

The result is increased efficiency in refining.

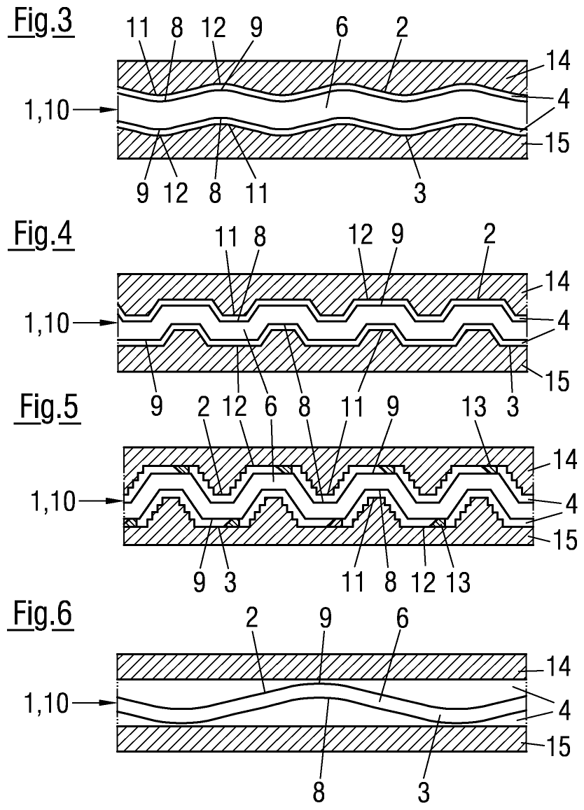

FIGS. 3 to 6 illustrate various arrangements of refining surfaces 2,3, according to other embodiments of the invention. Regardless of said arrangements however, the distance between refining bars 4 of opposite refining surfaces 2, 3, and the distance between grooves 5 of opposing refining surfaces 2,3 in radial direction 10 is the same.

In FIG. 6, grooves 5 have a constant height above supporting surface 17 in radial direction 10, according to an embodiment of the invention. This means that the height of refining bars 4 relative to the groove bottom changes in radial direction 10.

In contrast thereto, grooves 5 contribute to the turbulence in the examples illustrated in FIGS. 3 to 5. This means that also grooves 5 have annular elevations 11 and depressions 12 that run concentrically to axis of rotation 7 of refining surfaces 2, 3, whereby an annular elevation 11 of one refining surface 2, 3 protrudes into an annular depression 12 of opposite refining surface 2,3.

To avoid blockages due to constrictions, the radial position of elevations 8 or respectively depressions 9 of refining bars 4 corresponds with the radial position of elevations 11 or respectively depressions 12 of grooves 5 of a refining surface 2, 3.

In FIGS. 3 to 5—viewed in radial direction—the height of refining bars 4 above the groove bottom is the same.

It is for example however also possible that the height of grooves 5 relative to supporting surface 17 in radial direction 10 fluctuates less than the height of refining bars 4 relative to supporting surface 17.

In the interest of a homogeneous treatment during flow, elevations 8, 11 and depressions 9, 12 alternate in all arrangements and on both refining surfaces 2, 3 in radial direction 10.

In one embodiment, refining surfaces 2, 3 are to be designed depending upon cellulose fibers 1 that are to be treated and according to the requirements of such treatment.

FIG. 3 illustrates one design wherein the height of annular elevation 8, 11 or respectively depression 9, 12 on both refining surfaces 2, 3 as well as on refining bars 4 and grooves 5 gradually increases and gradually decreases in radial direction 10.

In FIG. 6 only the height of refining bars 4 changes gradually relative to supporting surface 17.

As shown in FIGS. 4 and 5, to further increase the level of turbulence, the height of annular elevation 8, 11 or respectively depression 9, 12 increases or decreases in radial direction 10 in one (FIG. 4) or several (FIG. 5) increments. In the case of several increments—as illustrated in FIG. 5—the transitions can progress perpendicular to the direction of flow.

In the case of only one increment between elevation 8, 11 and depression 9, 12 a slanted transition is to be recommended for minimization of wear and tear, according to FIG. 4.

In general, elevations 8, 11 and depressions 8, 12 extend over the entire refining surface 2, 3.

In many cases however—as can be seen in FIGS. 1 and 2—it is sufficient if elevations 8, 11 and depressions 9, 12 extend only over a partial radial section of refining surface 2, 3.

Additionally, barriers 13 can also intensify the fiber treatment, according to FIG. 5. Said barriers 13 close off grooves 5 completely or partially and can thus also support the shifting of the fibrous suspension between refining surfaces 2, 3.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A refining assembly for refining aqueous suspended cellulose fibers, comprising:
two refining surfaces arranged coaxially to one another and forming a refining gap, the two refining surfaces being rotatable relative to one another and are formed by refining bars and grooves extending between them, wherein at least one directional component of the refining bars extends radially relative to an axis of rotation, and wherein the refining bars have annular elevations and depressions that run concentrically to the axis of rotation of the refining surfaces, whereby an annular elevation of one refining surface protrudes into an annular depression of an opposite refining surface, refining sets that form the refining surface are fastened on a supporting surface, a spacing between the refining bars of the opposite refining surfaces in a radial direction is identical, a spacing between the grooves of the opposite refining surfaces in the radial direction is identical, and the grooves in the radial direction have a consistent height above the supporting surface.

2. The refining assembly according to claim 1, wherein a height of the annular elevation or respective depression is at least one of increasing gradually and decreasing gradually in the radial direction.

3. The refining assembly according to claim 1, wherein the elevations and depressions alternate in both refining surfaces in the radial direction.

4. The refining assembly according to claim 1, wherein the elevations and depressions extend only over a partial radial section of the refining surface.

5. The refining assembly according to claim 1, wherein the elevations and depressions extend over the entire refining surface.

6. The refining assembly according to claim 1, wherein at least some of the grooves are at least partially closed by barriers.
